(19) United States
(12) Patent Application Publication
(10) Pub. No.: US 2012/0038293 A1
(43) Pub. Date: Feb. 16, 2012

(54) LED Lighting Device

(76) Inventors: Salvatore Guerrieri, Jersey City, NJ (US); Steven Hamel, Covington, LA (US)

(21) Appl. No.: 13/029,057

(22) Filed: Feb. 16, 2011

Related U.S. Application Data
(60) Provisional application No. 61/338,164, filed on Feb. 16, 2010.

(51) Int. Cl. H05B 37/02; F21V 5/04; F21V 7/00; F21V 15/00; F21V 21/00

(52) U.S. Cl. 315/313; 315/312; 315/360; 362/362; 362/249.02; 362/296.01; 362/231; 362/311.02

(57) ABSTRACT

An LED lighting device is described that comprises of a housing. The housing is capable of engaging with a leg of a table via a hole in the center of the housing. The housing also contains a first LED light source, a power source to power said first LED light. The LED lighting device can also have a second or multiple LED lighting sources housed within the housing.

### CROSS-REFERENCE TO RELATED APPLICATIONS

This application relates to and claims priority rights from provisional application U.S. 61/338,164 filed on Feb. 16, 2010, the entire disclosures of which are hereby incorporated by reference herein.

### BACKGROUND OF THE INVENTION

1. Field of the invention

This invention relates to an apparatus for providing decorative LED based light.

2. Description of the Related Art

Lighting can often be used as a decorative tool. A lighting scheme will create a visual image that can be used to set an atmosphere of a room. Finding the right lighting device to achieve the desired visual effect can depend greatly on the particular circumstances of the situation. The location of the light source, the direction of where the light is to be shone, the colors of the light, the powering of the light source and the portability of light source are all considerations in implementing a lighting scheme.

One popular decorative lighting technique is to illuminate the underside of a table with a draped table cloth on top. Having the underside illuminated with the draped table cloth produces an elegant glow to the tables and the harshness of the direct light will be subdued due to the table cloth. Such an effect will be pleasing to the eye and can effect the proper atmosphere to a social event. Having the right lighting device to quickly and efficiently implement this effect can be important to people whose business is to provide the proper decoration and atmosphere to parties such as professional caterers or party planners.

One can accomplish this decorative effect by placing light sources on the floor underneath the table. This, however, can have several disadvantages. To achieve the desired effect, each light will have to be individually adjusted to ensure proper placement and that the light is shining in the correct place to have the desired effect. If the caterer has 100 tables on which to create this lighting effect, the time consumed can become a huge logistic problem.

In addition, as the lights are simply lying on the floor, there is a possibility that a light can be inadvertently shifted to change the lighting effect. Another problem exists because the lights can be hit and broken by the people that are around the table. Yet another problem occurs if the tables are subsequently moved, then the lights will also have to be moved. Again, for a large number of tables, this will involve a lot of time.

While it is possible to use tape or other temporary fasteners to attach the lights to the table, that would increase the amount of time and labor that would be needed to setup each table in addition to adjusting each light under the table to achieve the desired effect.

Another problem can occur if incandescent or fluorescent bulbs are used in this fashion as the resultant heat from the bulbs can be undesireable to the people gathered around the table.

An additional consideration that exists for the professional caterer is the prevention of theft of the lighting device.

### SUMMARY OF THE INVENTION

The above objects of the invention and advantages are achieved by having a central housing that will be able to accommodate one or more LED light sources. The housing will be easily engageable with the leg of the table such that it will move with the table. The engagement with the leg can be a hole in the middle of the housing through which the leg of the table will be insertable. With the use of a clamping device within the hole, the housing can be easily adjusted up and down to generate the desired lighting effect. For a table with a central column as the sole supporting leg of the table, engaging the housing with the table through this hole will ensure that the device is properly placed to create the desired lighting effect and that the device cannot be easily taken without disassembling the table. The use of LED lights will not generate as much heat as easily as other light sources would and it is also easier to implement different colors schemes.

### BRIEF DESCRIPTION OF THE DRAWINGS

FIG. 1a is a top view of one embodiment of the present invention.

FIG. 1b is a bottom view of one embodiment of the present invention.

FIG. 2 is a perspective view of one embodiment of the present invention.

FIG. 3 is a circuit diagram of the LED source in one embodiment of the present invention.

FIG. 4a is a perspective view of one embodiment of the present invention in use on a table.

FIG. 4b is a perspective view of one embodiment of the present invention in use on a table with a table cloth.

FIG. 5a-c are three perspective views of second embodiment of the present invention.

FIG. 6 is a top view of third embodiment of the present invention.

FIG. 7 is a top view of fourth embodiment of the present invention.

FIG. 8 is a top view of a fifth embodiment of the present invention.

FIG. 9 is a top view of a sixth embodiment of the present invention.

### DETAILED DESCRIPTION OF THE EMBODIMENTS

For the purposes of understanding the invention, reference will now be made to the embodiments illustrated in the drawings. It will be understood that no limitation of the scope of the invention is thereby intended. Any alterations and further modifications in the described embodiments, and any further applications of the principles of the invention as described herein are contemplated as would normally occur to one skilled in the art to which the invention relates.

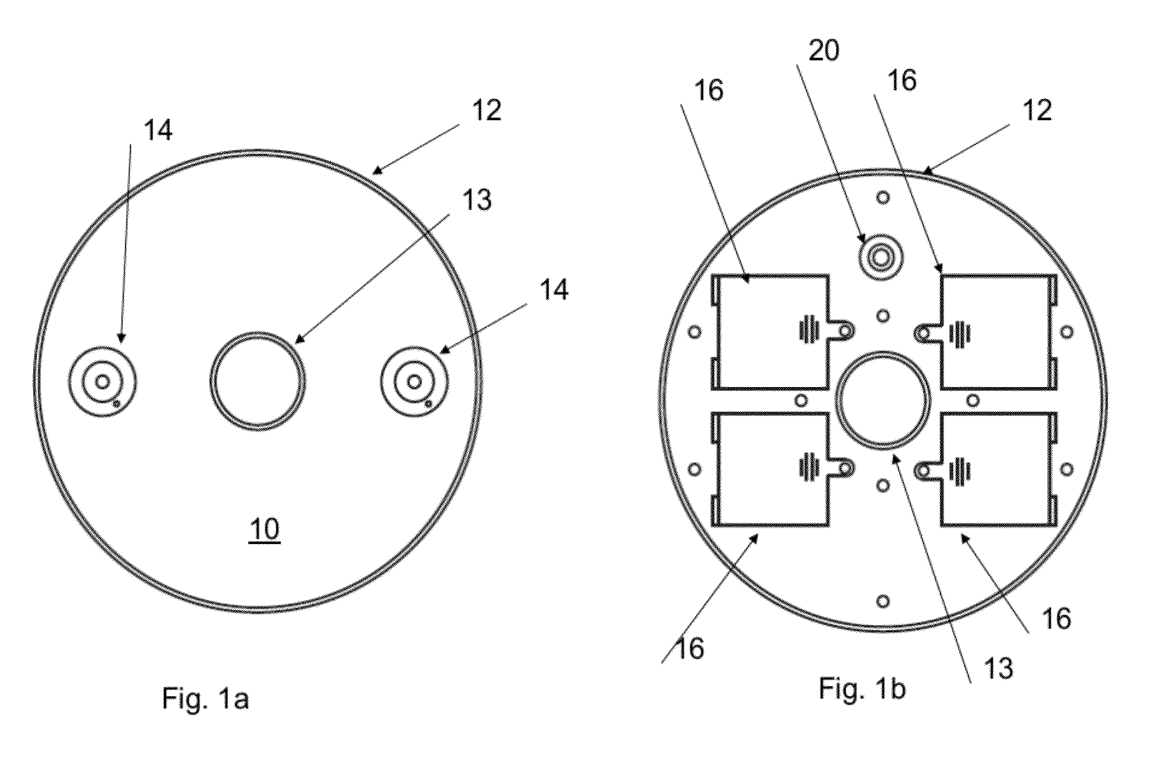

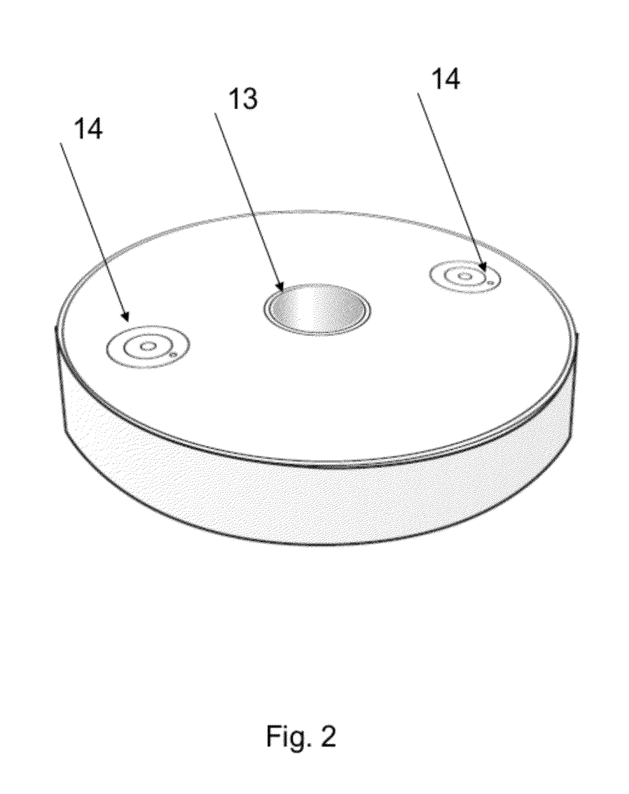

Referring to FIGS. 1a-b and 2, one embodiment of the invented LED device is depicted. The invented LED device 10 is composed of a circular housing 12 with a hole 13 that extends through the entire housing in the middle of the housing 12. The hole 13 can be of any size, but should be big enough to accommodate the standard width of a table leg. A typical table leg width can be approximately 22 mm and the hole 13 in the housing 12 should be large enough to accommodate any width of a table leg. A clamping device can be provided within the hole to allow the device to be fastened to the table leg at the desired height.

Two light emitting diode (“LED”) light sources 14 are placed on the top of the device. The LED light sources 14 are approximately 180 degrees away from one another on the top of the LED device. The LED light sources 14 will shine light in the direction above the device and can have an angular spread of approximately 180 degrees each.

Battery bays 16 are located on the bottom of the LED device 12. The battery bays 16 will house the batteries that can provide all of the power for the operation of all of the electric circuitry located on the device. Also, a master kill switch 20 is located on the bottom of the LED device. The master kill switch 20 will disable all power connections to the batteries in the battery bays in order to save power drain.

The LED light sources basically consists of a light emitting diode. It can also have additional accessories such as different angled lenses and/or reflectors to amplify the light in a particular direction. The lenses can be easily removed and replaced to allow a degree of flexibility in controlling the lighting effect. Circuitry to power and control the diode is also contained within the housing.

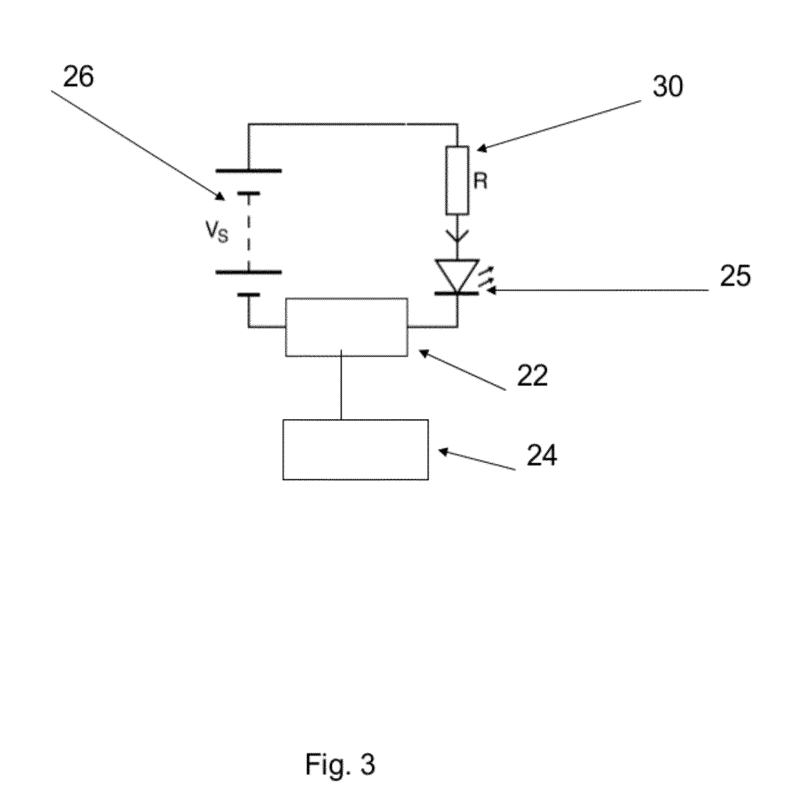

FIG. 3 details a typical electrical circuit to power the LED light source and shows a power source 26, control circuit 22 and resistance 30. Control circuit 22 will be able to control the power and the current fed to the LED thereby controlling the intensity of the light emitted. Remote control circuit 24 is connected with control circuit 22 and will able to receive remote signals from a user via infrared signals or RC or any wireless control system to allow a user to remotely control the LED light sources. The housing can be composed of any durable material, but should be capable of protecting the LED light sources and the circuitry contained therein.

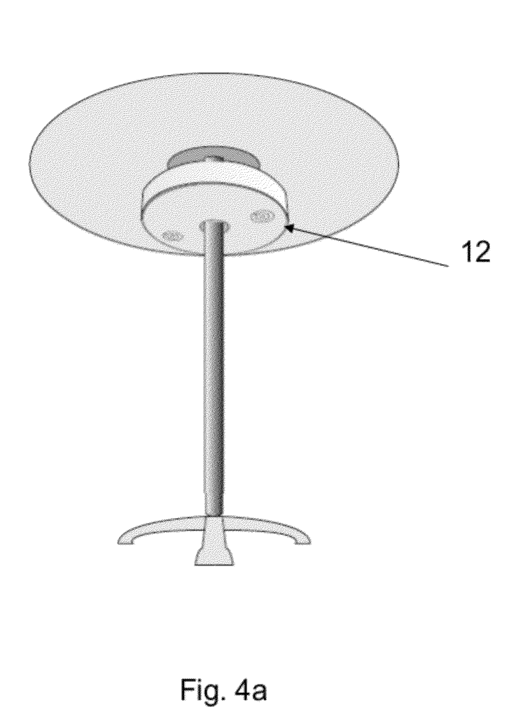

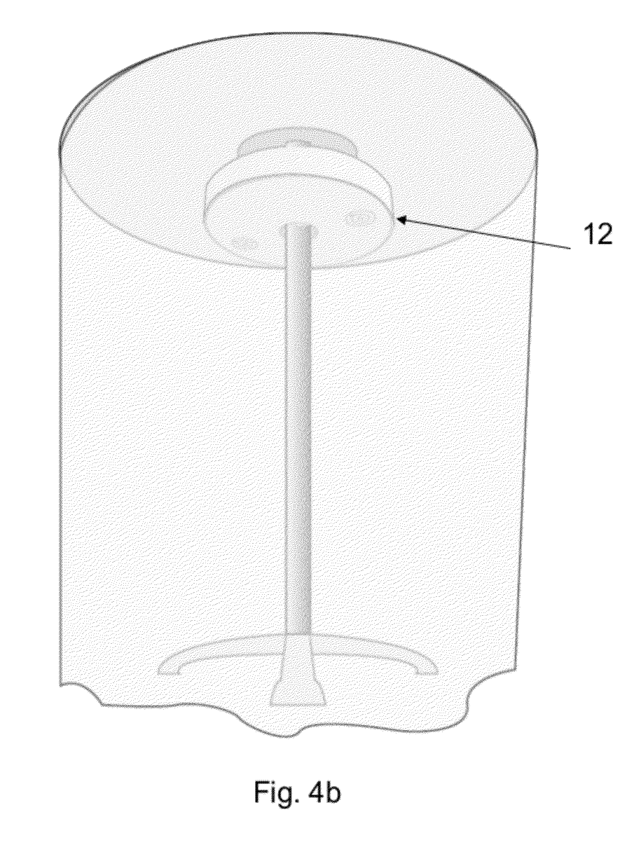

In operation, LED device 12 will be slid over a table leg. As shown in FIG. 4, the LED device 12 rests in between the base of the leg and the tabletop. In this depiction, the LED device is located very close to the tabletop and is shown to be facing downward with the LED light sources pointing down to the base. As such, the LED light sources will illuminate the floor and the area underneath the tabletop. As it is pointing downward, the light will not be glaring out at any person looking at the table. The LED device can just as easily be turned upside down so that the lights are pointing upward and the position of the LED device would likely be located closer to the base of the table rather than the tabletop. As shown in FIG. 4b, a table cloth can be placed over the table such that the light will illuminate the area behind the table cloth and create a glow behind the table cloth.

To insert the LED device onto the table leg, the LED device should be installed prior to assembling the table. Typically, the table will be unassembled and must be assembled prior to the event. As unassembled, the table leg will not be connected to the table top and will consist only of the cylindrical pole. To assemble the table, the cylindrical pole must be inserted into a hole in the table top and then attached to the base. Thus, the LED device can be easily fitted to the cylindrical pole by sliding the pole into the hole of the LED device first and then inserting the pole into the tabletop. Once the pole is inserted into the LED device, the LED device can be adjusted up and down easily and then secured at the desired height by a clamping device in the hole. By attaching the LED device directly to the table leg in this manner, it allows for the table to be moved without any disruption of the visual effect given by the illuminating light. In addition, as the LED device cannot be removed without disassembling the table, the LED device is less likely to be stolen.

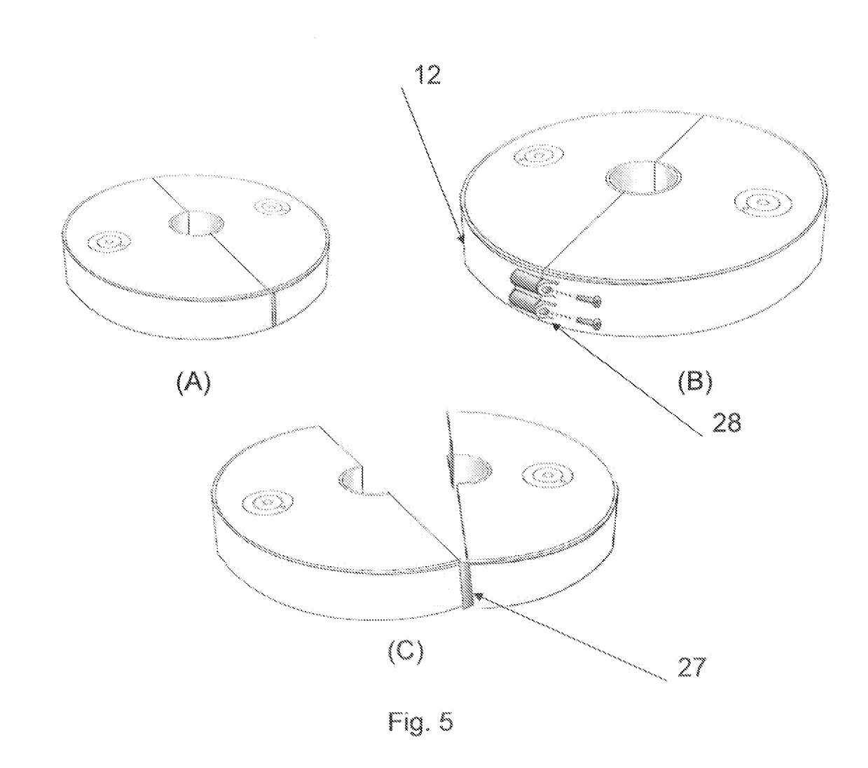

In an alternate embodiment, the LED device is attachable to the table leg after the table has been assembled. As seen in FIG. 5, the LED device is split into two components with each component connected together with a hinge 27. Hinge 27 allows the LED device to be separable enough so that the LED device can be fitted to the leg without having to insert the table leg through the hole. A secure fastener, such as screw assembly 28, will secure the LED device around the leg to protect against easy theft of the device. The LED device will still be adjustable up and down the leg after the screws have been secured to allow the device to be adjusted to achieve the desired lighting effect.

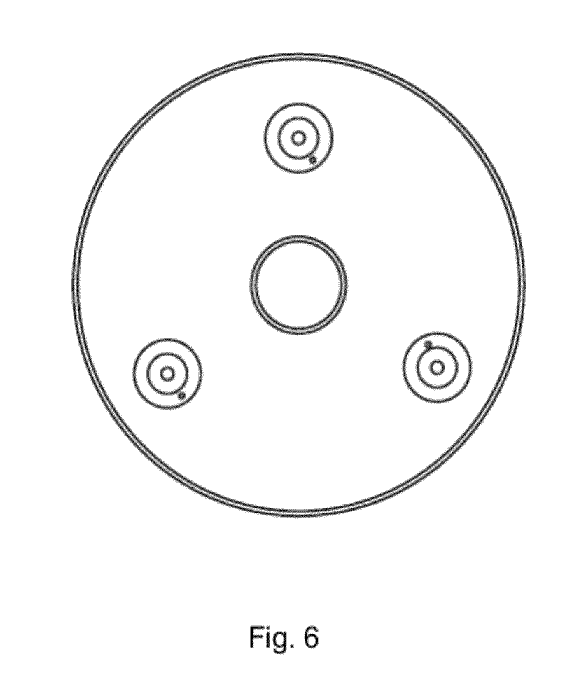

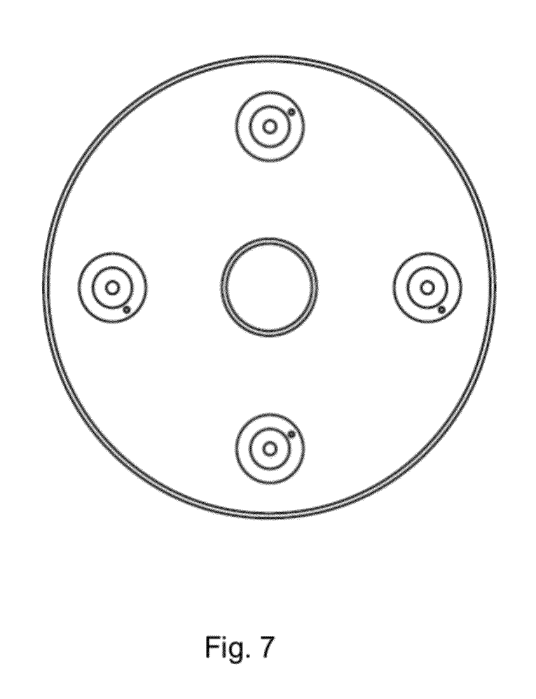

In FIGS. 6 and 7, two different embodiments are depicted that show that the LED device houses three and four LED light sources respectively. Each of the light sources will be equably spread out along the top of the LED device to ensure that the illumination is even. While each of these embodiments show the LED light sources as being on the top of the LED device, it would be understood by one of skill in the art that the light sources could also be placed on the sides of the housing and that the LED light sources could be any degrees apart from one another as long as the LED light sources are able to illuminate the area above the device.

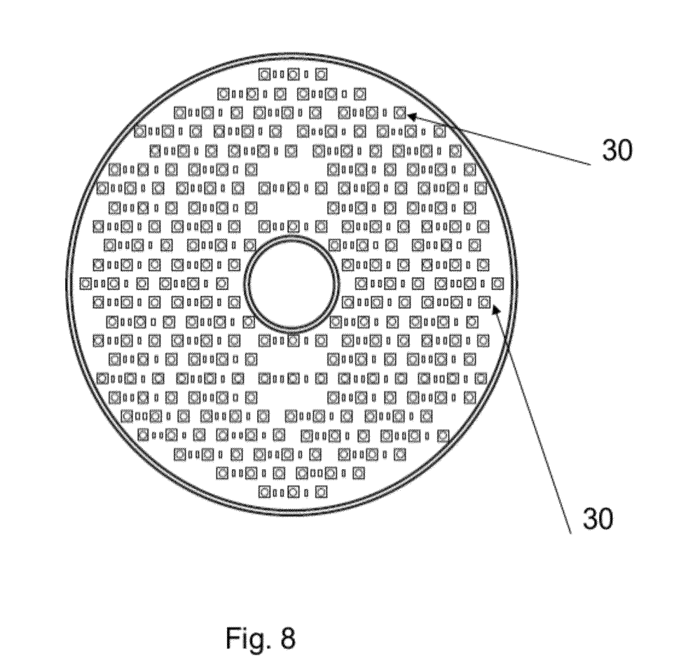

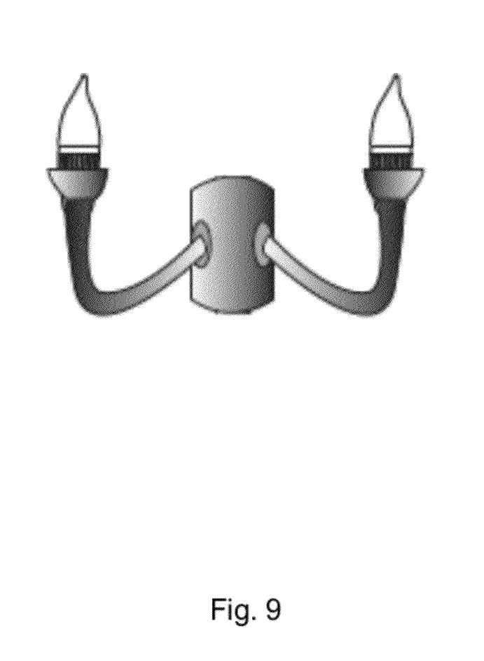

FIG. 8 shows a different embodiment where a multitude of LED light sources 30 are placed on the top of the LED device. Having multiple LED light sources allows the device to utilize different colored LEDs. In this embodiment, ⅙ of the LEDs are equally divided amongst the following colors: red, green, blue, amber, cool and warm white. By having different colored LEDs on the device, billions of different color combinations and/or shades of color can be created by lighting up differing colored LEDs. Such a variety of color combinations allows the device to produce the most popular combinations of colors to have the greatest visual effects. In addition, the control circuit would be able to effect timing sequences to allow the different effects to vary throughout the lighting.

FIG. 9 shows a different embodiment of the housing. In FIG. 9, the housing solely consists of a ring with two arms attached to the ring. Each of the arms will have the capability of housing the LED lighting sources. Other shapes for the housing can be implemented without deviating from the scope of the invention.

What is claimed is:

1. An LED lighting device, comprising:
a housing; said housing capable of engaging with a leg of a table;
a first LED light source located in said housing; said first LED light source connectable with a power source to power said first LED light and able to project light above said LED light source in said housing.

2. The LED lighting device as recited in claim 1, further comprising a second LED light source located in said housing and positioned to project light in the same direction as said first LED light source.

3. The LED lighting device as recited in claim 1, wherein said housing engages with a leg of the table via a hole located in said housing.

4. The LED lighting device as recited in claim 1, wherein said power source is located in said housing.

5. The LED lighting device as recited in claim 1, further comprising a remote control circuit to allow said first LED lighting source to be controlled remotely.

6. The LED lighting device as recited in claim 1, wherein said first LED lighting source comprises a multi-colored LED.

7. The LED lighting device as recited in claim 1, wherein said first LED lighting source comprises an LED and a reflector.

8. The LED lighting device as recited in claim 2, wherein said second LED lighting source is a different color than said first LED lighting source.

9. The LED lighting device as recited in claim 2, wherein said first and second LED lighting sources comprises a color selected from the group of colors comprised by red, green blue, amber, warm and cool white.

10. The LED lighting device as recited in claim 3, wherein said housing is an integral unit.

11. The LED lighting device as recited in claim 3, wherein said housing is comprised of a first and second separable component; said first and second separable component being connected along one side by a hinge and a fastening device on the other side to fasten the first and second components together.

12. The LED lighting device as recited in claim 2, wherein said first and second LED light sources are located on opposite sides of said housing.

13. The LED lighting device as recited in claim 4, further comprising a master power kill switch to disable the power connection between said LED light sources and the power source.

14. The LED lighting device as recited in claim 1, wherein said first LED light source comprising removable lenses.

15. The LED lighting device as recited in claim 1, wherein said LED light source comprises an LED control circuit to control the power to the LED and the intensity of the LED.

16. An LED lighting device, comprising:
A housing; said housing having a hole capable of having a table leg inserted in said hole;
An LED light source located in the top of said housing; positioned to illuminate the area on top of said housing.

17. The LED lighting device a recited in claim 16, further comprising a plurality of LED light sources.

18. The LED lighting device a recited in claim 17, wherein said plurality of LED light sources are capable of displaying colors in red, green, blue, amber, warm and cool white.

19. The LED lighting device a recited in claim 18 further comprising a control circuit that is able to turn the plurality of LED light sources according to a timing schedule.

20. An LED lighting device, comprising:
a housing; said housing having a hole in the middle which is capable of engaging a table leg;
at least two LED light sources located in said housing, positioned in said housing to illuminate light in the substantially the same direction as each other.
